(19) United States
(12) Patent Application Publication
(10) Pub. No.: US 2009/0198704 A1
(43) Pub. Date: Aug. 6, 2009

(54) Method for automated network file and directory virtualization

(76) Inventor: Klavs Landberg, Wolfeboro, NH (US)

Correspondence Address: DEVINE, MILLIMET & BRANCH, P.A., 111 AMHERST STREET, BOX 719, MANCHESTER, NH, 03105, US

(21) Appl. No.: 12/321,829

(22) Filed: Jan. 26, 2009

Related U.S. Application Data
(60) Provisional application No. 61/062,405, filed on Jan. 25, 2008.

(51) Int. Cl. G06F 17/30; G06F 12/00; G06F 12/16

(52) U.S. Cl. 707/10; 707/204; 709/203; 707/E17.01; 707/E17.007; 707/E17.044; 707/E17.032; 711/E12.103

(57) ABSTRACT

A system and method for managing the locations of files in a network such that application programs in client computers that need access to those files do not need reconfiguration when those locations are changed. Further, the system and method allows the resolution of the ‘virtual’ location known to the client computer or application to a current physical location to be performed using a single referral. In addition, the system and method provides for the automatic updating of the ‘namespace’ that tracks the relationship of ‘virtual’ location to current physical location.

### CROSS-REFERENCE TO RELATED APPLICATIONS

The present claims the benefit of Provisional Patent Application No. 61/062,405 filed Jan. 25, 2008, which is incorporated herein by reference.

### TECHNICAL FIELD

The present invention relates to software. More specifically, it relates to software for automated file virtualization for movement and management of data files and directing access to the data files.

### BACKGROUND INFORMATION

The use of networked access to files has evolved by necessity and usually without a long-term plan. In the computer network, it has become usual to store data in, and retrieve data from, storage devices managed by one or more computers dedicated to the task of providing access to data. The computers that manage the devices are known as filers.

The data on these storage devices are organized into named files. Files are recorded as entries in directories. Directories may contain entries both for files and for child directories (subdirectories). This hierarchical structure is defined as a file system, and the unit of storage containing a complete file system is called a volume. A volume is controlled by means of file system software. The path from a starting directory through the hierarchy to a given file or directory within the directory tree is represented by a string of element names each separated from the previous element by a separator character. Each element but the last, names a subdirectory of the directory named by the preceding element, and the last element names the target file or directory within the penultimate element. The string usually starts with a separator character, and denotes the root of the tree. The separator character is usually a backslash (‘\’), so an example of a path is \Staff\Accounting\JohnJolly\Resume.doc

Access to files and directories within a volume is provided to client computers in the network by means of ‘share’; a share is a named reference to a directory that is published by network software on the filer. Through a share, client computers may gain access to file and directory resources within a directory tree on the filer.

Over time, the network access to and management of files has escalated beyond the practical limits of manual manageability. In addition, exploding capacities and strict uptime requirements have made data migration and storage consolidation hard to reach goals in many organizations. As a result, old, underpowered, and expensive resources cannot be retired while newer, cost-effective resources cannot be fully utilized.

In particular, clients are connected to their files by network folders or drive letters that directly identify physical resources. Moving some files for a few clients is manageable enough, but moving large numbers of files used by hundreds or even thousands of clients involves both downtime and client configuration changes that are usually prohibitive.

In addition, files are often referred to as “unstructured” data. There is overwhelming evidence that unstructured data is often replicated, poorly organized, and poorly utilized. People email copies around rather than locating the central original. Departed employees or cancelled projects leave orphaned files behind. Downloads from the Internet often create files that never should have existed on corporate resources. Data classification tools may be used to explore the problem, but improvements are very hard to implement due to uptime requirements and workload availability.

Thus, a solution is needed for these problems while preserving and enhancing existing information technology (“IT”) infrastructures and leveraging in-house capabilities. The deployment of such a solution and subsequent data migration should be automated, seamless, and transparent. It should also provide both limitless scalability and high availability.

### SUMMARY

The invention provides a method for managing the locations of files in a network such that application programs in client computers that need access to those files do not need reconfiguration when those locations are changed. Further, it allows the resolution of the ‘virtual’ location known to the client computer or application to a current physical location to be performed using a single referral. Finally, it provides for the automatic updating of the ‘namespace’ that tracks the relationship of ‘virtual’ location to current physical location.

In accordance with one aspect of the present invention, a system for storing data on a network or backbone. The system includes a server computer having an SMB driver, server software, a file system driver and a name space system (NSS). The server computer is connected to the backbone. A filer computer contains a plurality of data. The filer computer is connected to the backbone. The client computer is connected to the backbone for accessing data from the filer computer. The name space system (NSS) includes a NSV (name space volume) containing a representation of data on the filer. A NSNFD (Name Space Network Filter Driver) is interposed between the backbone and the SMB driver of the server computer for modifying the request (the filer and share name) from the at least one client computer prior to forwarding it to the server software. A NSFSFD (Name Space File System Filter Driver) is interposed between the server software and the file system driver for providing Reparse Point Functionality in the NSV for the at least one client computer therein the at least one client computer reissues the request for data with a revised file location. A NSIS (Name Space Information Server) maintains a database relating the filer and share name to the location in the NSV of representation of a specific data on the filer. The UNC path stored on the at least one client computer can locate the data regardless of the actual physical location on the filer computer. A FIM (Filer Inventory Module) creates and updates the representations in the NSV. A SMM (Share Migration Module) moves data from one filer share to another.

In an embodiment, the plurality of data are located on a plurality of storage volumes on a plurality of filer computers and wherein the data is located in a directory structure including at least one root folder, a plurality of shared folders and a plurality of folders which are not shared, the data located in the pluralities of folders.

The invention relates to a Name Space System including a NSV (name space volume) containing a representation of the organization of shares on the filer. A NSNFD (Name Space Network Filter Driver) is interposed between the backbone and the SMB driver software of the server computer for modifying the request including the filer and share name from the at least one client computer prior to forwarding to the server software.

A NSFSFD (Name Space File System Filter Driver) is interposed between the server software and the file system driver for providing Reparse Point Functionality in the NSV for the at least one client computer therein the at least one client computer reissues the request for data with a revised file location. A NSIS (Name Space Information Server) maintains a database relating the filer and share name to the location in the NSV of the representation of a specific data on the filer. The UNC path stored on the at least one client computer can locate the data (independently) regardless of the actual physical location on the filer computer.

In an embodiment for managing data (file) retrieval, data is requested from the backbone by a client computer. The request for data is intercepted by a name space system. The name space system determines if the path for the data has been modified. The name space system modifies the path for the data. The name space system forwards the path for the data to the client computer requesting the data.

In an embodiment, the FIM in the NSS assigns a new unused network name for a filer. A directory is created on the NSV having the network name of the filer wherein the data is physically located. A subdirectory is created within the directory on the NSV for each of the shares located on the filer. The FIM applies the new unused network name to the filer.

In an embodiment, the FIM uses the volume information associated with each of the shares to determine what subset of the directory structure of the share to analyze and record in the NSV.

In an embodiment, a Reparse Point is created by the FIM at each leaf subdirectory within the directory on the NSV, the Reparse Point containing the UNC (Uniform Naming Convention) path to the physical location of the data. Database entries are also created to record, for each physical location, its associated Reparse Point location in the NSV.

In an embodiment, a client application on a client computer submits an open request using the UNC path related to the data. using the SMB (Server Message Block) protocol. The client computer submits a request to the DNS (network address resolution directory) to obtain the network address of the filer named in the UNC path related to the data. DNS responds with the network address of the NSS server computer. The network name of the filer exists as a directory within the NSV. The NSNFD (Name Space Network Filter Driver) on the NSS server computer intercepts the SMB request which includes the filer and share names and local path components. The NSNFD inquires of the NSIS whether the filer name is represented in the NSV. The NSIS looks up in the (root directory) of the NSV and communicates the result to the NSNFD.

In an embodiment wherein the filer directory is present in the NSV, the NSNFD extracts the filer and share components of the UNC path from the open request and stores them temporarily. The NSNFD replaces the filer name component of the UNC path with the NSS computer network name and the share component of the UNC path with the NSV share name. The NSNFD prepends the stored filer name and share to the local path component of the UNC path as the first two elements. The NSS forwards the modified request to the SMB driver on the NSS server computer. The SMB driver communicates the server software, which submits a file system open request containing the modified local path component of the UNC Path in the request to the file system driver in the NSS server computer.

To process the file system open request, the file system driver looks up each successive element of the local path within the NSV subdirectory identified by the preceding element. If a matching subdirectory is found for an element which is a leaf directory in the NSV directory structure, it will have been marked as a Reparse Point, in which case the file system driver ceases processing further elements of the local path in the open request, and sends a response back to the server software indicating that a reparse point has been encountered. The NSFSFD intercepts the response returned by the file system driver, and uses the contents of the reparse point to cause the local path elements processed up until the reparse point was encountered to be replaced by a UNC path representing the physical location of the remaining, unprocessed local path. It then forwards the modified result to the server software, which sends the result back to the client computer. The SMB driver in the client computer sends a new request using the modified path in the result of the original request. This set of events is called a referral.

If on the other hand all of the elements of the local path in the file system open request match a subdirectory, but the final element does not match a leaf subdirectory, then the file system driver will respond with a successful status, indicating that the local path has been successfully opened. In this case, the NSFSFD forwards the result to the server software without modification. The server software sends the successful result back to the client computer.

In an embodiment, of a method where a filer is not located on the NSV, the request from the client computer is passed through to the server software unmodified by the NSNFD.

In an embodiment, the FIM compares a current directory structure in the filer computer to a specified directory structure in the NSV (name space volume). The specified directory structure in the NSV is modified to reflect the current directory structure in the filer computer, wherein the FIM is able to maintain an accurate representation of the filer.

In an embodiment of a method where a share exists in NSV but no longer exists at the filer and the corresponding Reparse Point does not indicate that the share has been migrated, the FIM removes the share directory in the NSV.

In an embodiment of a method where a share exists at the filer, but the share is not represented in the NSV, the FIM creates a directory for the share within the filer directory in the NSV.

In an embodiment of a method where the new share is a nested share, the FIM creates a directory tree from the parent share mirroring only enough of the directory structure at the filer necessary to relate the new nested share.

In an embodiment, a source and a destination of data to migrate are received by the name space system. The SMM (Share Migration Module) disables the source share at the source filer. The SMM creates the destination share at the destination filer. The SMM communicates with the NSIS to find the Reparse Point of the share. The SMM updates the Reparse Point data with the UNC path of the destination filer and share. The SMM removes the source share at the source filer.

In an embodiment of a method, the data is copied from the source filer to the destination filer and the data and the directory structure is deleted from the source filer.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram showing the configuration of a computer system according to an embodiment of the invention;

FIG. 2 is a diagram of a filer directory structure;

FIG. 3 is a diagram of the different ways Windows keeps client shortcuts;

FIG. 4 is a diagram of the properties of a certain file;

FIG. 5 is a diagram of a substitution table;

FIG. 6 is a diagram showing an example volume and share configuration at a filer in a network system;

FIGS. 7A & 7B are flowcharts describing the process of constructing an inventory of a filer to be managed;

FIG. 8 is a diagram showing a Name Space representation of the example in FIG. 6;

FIG. 9A is a flowchart describing the processing at the server computer of an SMB interaction with a client computer using the Name Space Network Filter Driver;

FIG. 9B is a flowchart describing the processing at the server computer of an SMB interaction with a client computer using the Names Space File System Filter Driver;

FIG. 10 is a flowchart describing the process for migration of a share from one filer to another;

FIG. 11 is a flowchart describing the process of re-inventorying a filer; and

FIG. 12 is a table of an example call to NetShareEnum targeting server.

### DETAILED DESCRIPTION OF THE PREFERRED EMBODIMENTS

A system and method for managing the locations of files in a network such that application programs in client computers that need access to those files do not need reconfiguration when those locations are changed. Further, the system and method allows the resolution of the unchanging ‘virtual’ location known to the client computer or application to a current physical location to be performed using a single referral. In addition, the system and method provides for the automatic updating of the ‘namespace’ that tracks the relationship of ‘virtual’ location to current physical location.

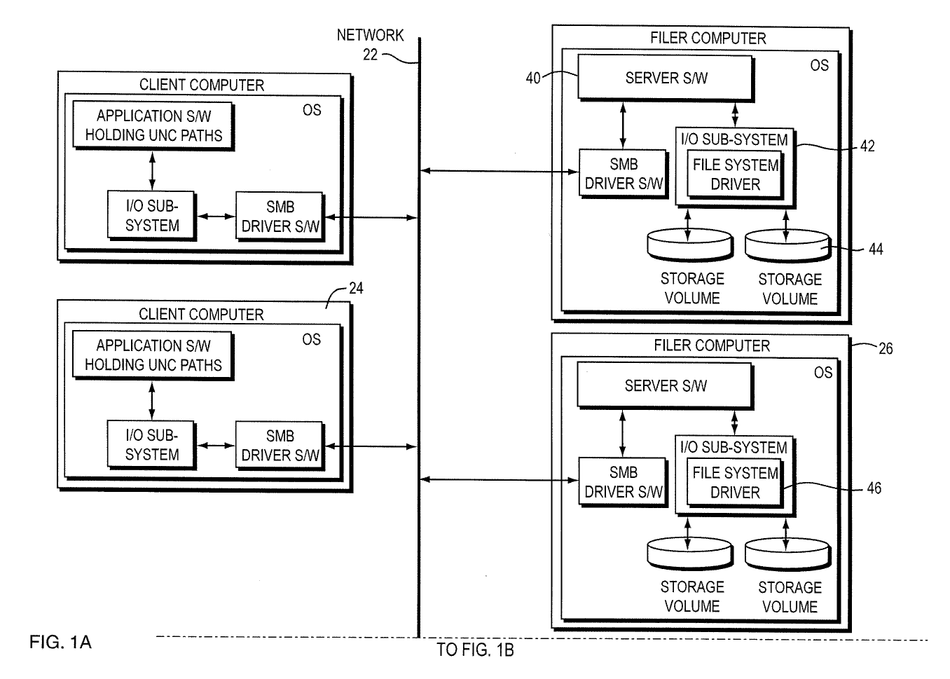

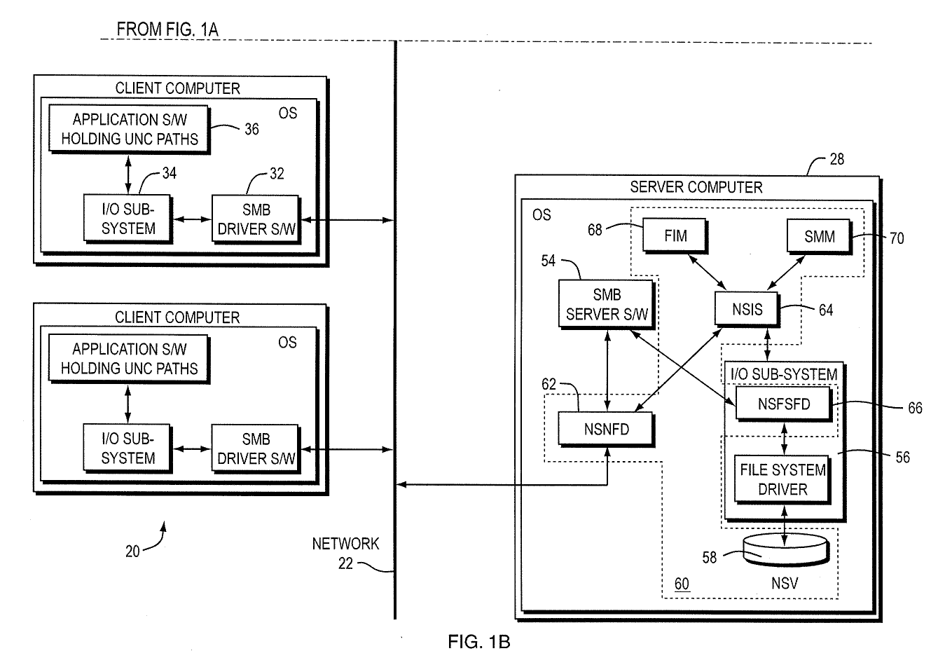

Referring to FIG. 1, a diagram of a computer system 20 is shown. The computer system 20 has a network or backbone 22, a plurality of client computers 24, a plurality of filer computers 26, and a server 28. Sometimes the entire system 20 is referred to as a network. To avoid confusion, the term “network system” 20 will refer to the entire system 20 and the term “backbone” will be used to refer to the network or backbone 22.

Each of the client computers 24 has various components including both hardware and software. These components of the client computer 24 include Server Message Block (SMB) driver software as represented by block 32 which interacts with the backbone 22. The SMB driver software 32 interacts with an Input/Output (I/O) sub-system 34 to access and send and receive data to and from the backbone 22. The client computer 24 in addition has application software as represented by block 36. The application software 36 contains Uniform Naming Convention (UNC) paths for the files that need to be accessed. The client computer 24 has an operating system as symbolized by the OS in the FIG which manages the various components of the computer 24.

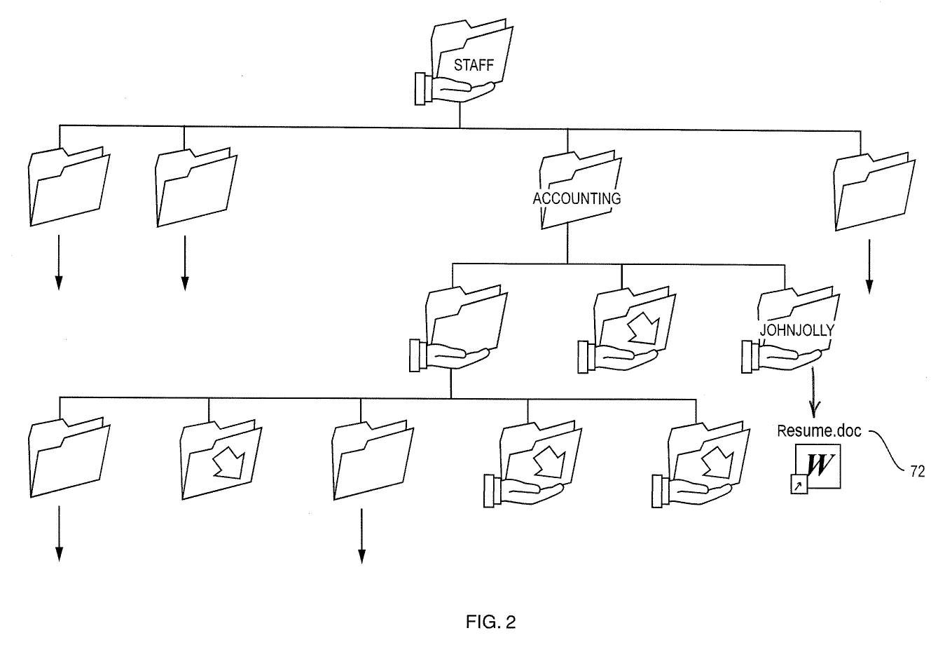

The filer computer 26, like the client computers 24, includes Server Message Block (SMB) driver software as represented by block 32 which interacts with the backbone 22. In addition, the filer computer 26 has server software which is represented by block 40. The server software 40 manages the folders and files on the filer computer 26 on behalf of client computers 24. In addition the filer computer 26 has an Input/Output (I/O) Sub-system as represented by block 42 and at least one storage volume 44 managed by a file system driver 46. The data and files 72 such as represented in FIG. 2, which are manipulated by the application software 36, are stored on the storage volume 44. The filer computer 26 has an operating system as symbolized by the OS in the FIG which manages the various components of the computer 24.

While the application software 36 is shown on the client computer 24, it is recognized that the application software 36 can be located at other locations such as the server computer 28.

The data on the storage devices, the filer computers 26, are organized into named files. Files are recorded as entries in directories. Directories may contain entries of both files 72 and child directories (subdirectories) as seen in FIG. 2. This hierarchical structure is defined as a file system. Referring back to FIG. 1, the computer or network system 20 has a pair of filer computers 26 each having a pair of storage volumes 44. The storage volume 44 is controlled by means of a file system driver. The path from a starting directory through the hierarchy to a given file or directory within the directory tree is represented by a string of element names each separated from the previous element by a separator character. Each element but the last names a subdirectory of the directory named by the preceding element, and the last element names the target file or directory within the penultimate element. The string usually starts with a separator character, and denotes the root of the tree. The separator character is usually a backslash (‘\’). An example of a path is \Staff\Accounting\JohnJolly\Resume.doc as seen in FIG. 2

Access to files and directories within a storage volume 44 is provided to client computers 24 in the backbone 22 of the system 20 by means of a ‘share;’ a share is a named reference to a directory that is published by network software on the filer. Published means being allowed to be visible to other computers in the computer system 20 through network protocols that respond to discovery messages. Through a share, client computers 24 may gain access to files and directory resources within a directory tree on the filer computer 26.

Over time, the network access to and management of its files has escalated beyond the practical limits of manual manageability. In addition, exploding capacities and strict uptime requirements have made data migration and storage consolidation hard to reach goals in many organizations. As a result, old, underpowered, and expensive resources cannot be retired while newer, cost-effective resources cannot be fully utilized.

In particular, clients are connected to their files by network folders or drive letters that directly identify physical resources. Moving some files for a few clients is manageable enough, but moving large numbers of files used by hundreds or even thousands of clients involves both downtime and client configuration changes that are usually prohibitive.

In addition, files are often referred to as “unstructured” data. There is overwhelming evidence that unstructured data is often replicated, poorly organized, and poorly utilized. People email copies around rather than locating the central original. Departed employees or cancelled projects leave orphaned files behind. Downloads from the Internet often create files that never should have existed on corporate resources. Data classification tools may be used to explore the problem, but improvements are very hard to implement due to uptime requirements and workload availability.

Administrators of computer networks have found that it is desirable to move shared directory trees either from one filer to another, or from one physical device to another on the same filer, in order to redistribute client load or space utilization on physical storage devices. Such a movement, termed ‘migration’ from here on, has required that the administrator modify affected UNC paths stored at all affected client computers. In networks comprised of very large numbers of computers, this can be a prohibitive problem, and is in any case disruptive for often long periods of time to users of the affected filers and shares. The computer system 20 of the instant invention is addressed in more detail after the following section.

Terminology and Acronyms

As in many industries, the network system and file management industry uses a lot of acronyms and terms that are unique to the industry. In addition, while the acronym is listed the first time of use, the following gives a list of terminology and acronyms for ready reference:

ACL—Access Control List;

CIFS—Common Internet File System. Similar to SMB;

Client or client computer—A client or client computer 24 is a computer system that is accessing filers using the SMB protocol. Accessing includes browsing, file creation, deletion, renaming, open, close, and I/O.

DNS—Domain Name Server—distributed service that runs in many locations throughout the system, and allows computers, individually named and collected in named domains, to be located, and their network addresses obtained. Domain Naming System is a distributed service that runs in many locations throughout the computer system 20, and allows computers, individually named and collected in named domains, to be located, and their network addresses obtained. DNS runs as a service on server class computers; each DNS service has a role in what is a global hierarchically organized system designed to allow a user of the system to ‘home in’ on a particular computer amongst the millions that make up the internet.

Filers—In a preferred embodiment, the computer system 20 of the instant invention works with Windows File Servers and all NAS devices that support the SMB protocol. These devices combine storage capacity with file system intelligence. Regardless of vendor, they are all called filers. Their names are referred to as filer names.

FIM—Filer Inventory Module;

I/O Input/Output;

Leaf Level Shares—a share that does not contain any other shares within the file system subset that it points to;

Local Path—a path to a file or directory in which already orientated to a particular share at a filer;

MMC—Microsoft management control;

Nested Share—a share that is mapped to a file system location that exists within the file system subset pointed to by another share;

Network Name—name used to identify a computer in a network;

NSFSFD—Name Space File System Filter Driver;

NSIS—Name Space Information Server;

NSNFD—Name Space Network Filter Driver;

NSS—Name Space System;

NSV—Name Space Volume;

Reparse Point—a special form of file or directory which contains no data, but rather a substitute path. When opened, the reparse point triggers a referral response back to the requester containing the substitute path such that the original request is resubmitted down a different path.

Shares—A share is a pointer to a subset of a file system that a filer makes available to clients on a network. On the network and in the client's computer, a share is identified by the filer name and its subordinate share name. In filers, each share is identified by name and mapped to the path from the root of the filer to the shared-out file system subset.

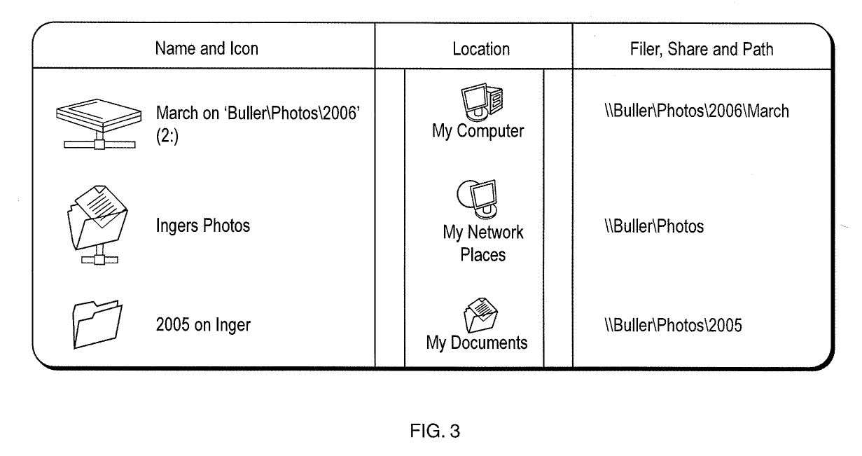

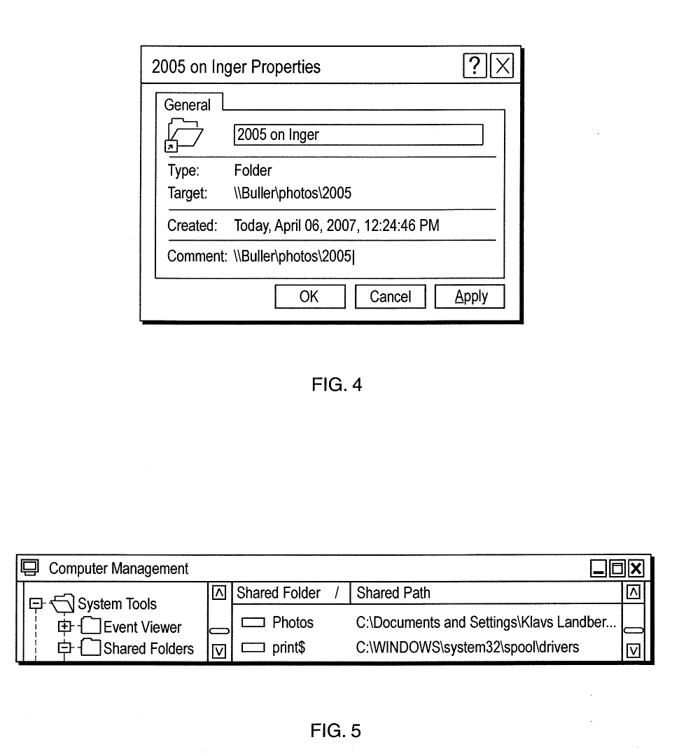

Shortcuts—A shortcut is a client object containing filer, share, and path information. Windows clients keep shortcuts in at least three different ways as shown in FIG. 3. In FIG. 3 the Z drive is a subset of a share that is referenced by a drive letter. The “folder on a pipe” icon is a shortcut to the complete share. The folder “2005 on Inger” is mapped to another subset of the share. The regular looking folder named “2005 on Inger” is shown in FIG. 3 as belonging in “My Documents,” but it may be located anywhere in the client system, for example, on the desktop. Its properties are described in FIG. 4.

The path in a shortcut does reduce the scope of the file system as seen by the client, but it is not a secure method for preventing visibility into potentially sensitive areas. Any user is capable of changing his shortcuts so security must be implemented outside the clients. In secure environments, shortcuts usually point directly to shares with access control list (“ACL”) security so that the path option in client shortcuts is avoided. In non-secure environments, the path option can be used to reduce the number of filer shares.

When a client uses a shortcut, for example to open the file “Z:\The Kids.jpg,” two substitutions take place. First, the client sends the file name “\Photos\2006\March\The Kids.jpg” to the filer named “Buller.” Second, Buller then substitutes the share name “Photos” with its path using a table such as the table shown in FIG. 5. The net result is a file name constructed from three separate sources: C:\Documents and Settings\Klavs Landberg\My Documents\Photos\2006\March\The Kids.jpg.

SMB—Server Message Block—an application-level network protocol mainly used to provide shared access to files, printers, serial ports, and miscellaneous communications between nodes on a network;

SMM—Share Migration Module;

UNC—Uniform Naming Convention—UNC paths are made up of three component parts: the network name of the filer; the name of a share published by that filer; and a local file system directory path as defined above from the location of the share to the targeted resource on the filer. This is represented in the form: \\filer\share\localpath. The client computer records a location for a given file or directory resource on a filer in the form of a Uniform Naming Convention (UNC) path;

Volume information—includes attributes of the volume such as its name (also known as the volume label), its size, the file system in which it is formatted, whether it is write-once (like a CD-R), supports compression, encryption, etc.

File Storage and Access in General—In a computer network, it has become usual to store data in, and retrieve data from, storage devices managed by one or more computers dedicated to the task of providing access to data. Such a computer is known as a filer.

The data on these storage devices are organized into named files. Files are recorded as entries in directories; directories may contain entries both for files and for child directories (subdirectories). This hierarchical structure is defined as a file system, and the unit of storage containing a complete file system is called a volume. A volume is controlled by means of a file system driver. The path from a starting directory through the hierarchy to a given file or directory within the directory tree is represented by a string of element names each separated from the previous element by a separator character. Each element but the last names a subdirectory of the directory named by the preceding element, and the last element names the target file or directory within the penultimate element. The string usually starts with a separator character, and denotes the root of the tree. The separator character is usually a backslash (‘\’), so an example of a path is \Staff\Accounting\JohnJolly\Resume.doc

Access to files and directories within a volume is provided to client computers in the network by means of a ‘share’; a share is a named reference to a directory that is published by network software on the filer. Through a share, client computers may gain access to files and directory resources within a directory tree on the filer.

The client computer records a location for a given file or directory resource on a filer in the form of a Uniform Naming Convention (UNC) path. UNC paths are made up of three component parts: the network name of the filer; the name of a share published by that filer; and a local file system directory path as defined above from the location of the share to the targeted resource on the filer. This is represented in the form: \\filer\share\localpath

When a client computer 24 wishes to open a resource such as a file or a directory it uses a network address resolution directory (DNS) to resolve the ‘filer’ component of the UNC path into a network address for the network name of the filer computer. The operating system of the client computer 24 then communicates with the filer to open the resource at the specified local path within the share, as those are specified in the UNC path.

The above list of terminology and acronyms is not meant to be exclusive of other definitions or meanings. Those skilled in the art will appreciate that a lengthy or specific definition may be helpful in understanding a specific embodiment.

Referring back to FIG. 1, the server computer 28 of the computer system 20 of the instant invention has a SMB Server Software as represented by block 54, an Input/Output (I/O) Sub-system as represented by block 56, at least one file system driver and at least one storage volume 58.

The SMB Server Software 54 is a combination of the SMB Driver Software 32 and the Server Software 40. That combination is present in both the server computer that hosts the invention and all filer computers 26. The only significant difference between a filer computer and the server computer described in this embodiment is the purpose: a filer is a specialized form of server computer tailored for the storage of files, whereas the server computer hosting the invention is of a more general purpose type.

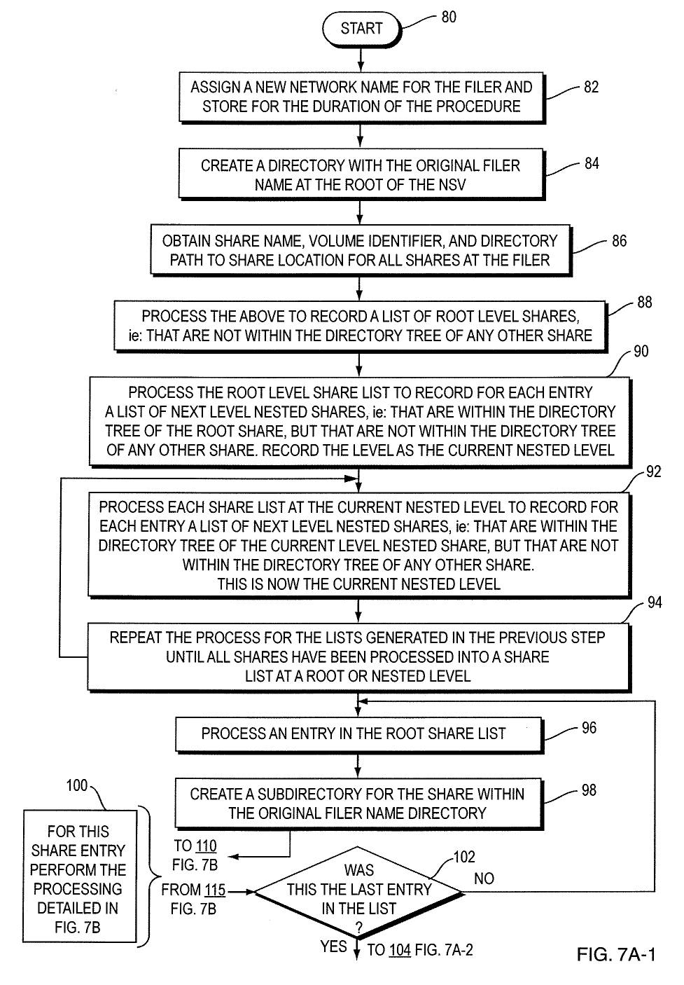

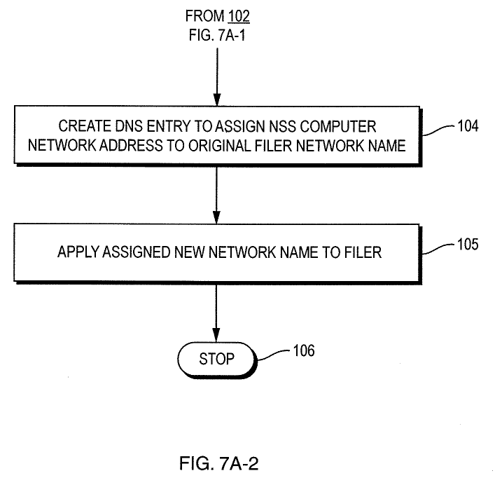

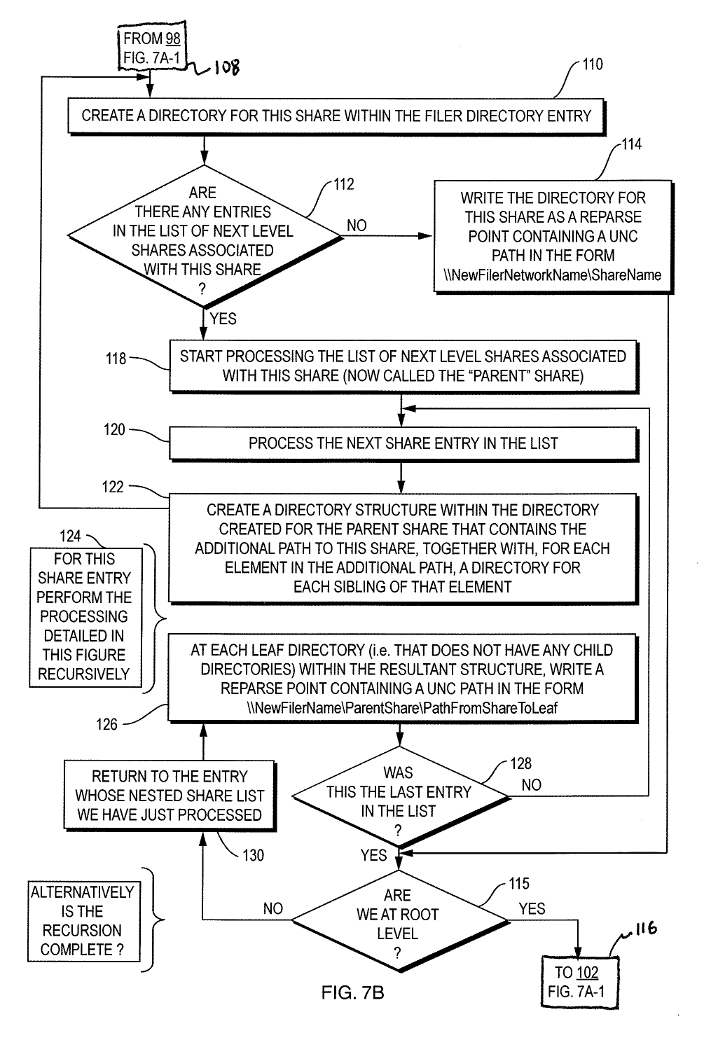

In addition, the computer system 20 of the instant invention has a name space system 60 carried in the server computer 28. The name space system (NSS) 60 has a Name Space File System Filter Driver (NSNFD) as represented by block 62, a Name Space Information Server (NSIS) as represented by block 64, Name Space File System Filter Driver (NSFSFD) as represented by block 66, and the storage volume 58, which is the Name Space Volume (NSV). In an embodiment, the Name Space System (NSS) 60 is configured as a software system on a server computer 28. The Name Space Volume (NSV) 58 of the NSS 60 contains a file system representation of the filers under management and the relationship between a filer and its shares. The process is further described below with respect to FIGS. 7A & 7B. Each leaf directory (a leaf has no child file system elements) is implemented as a Reparse Point. The root directory of the NSV is published from the computer using an assigned share name, known from here on as the NSV share.

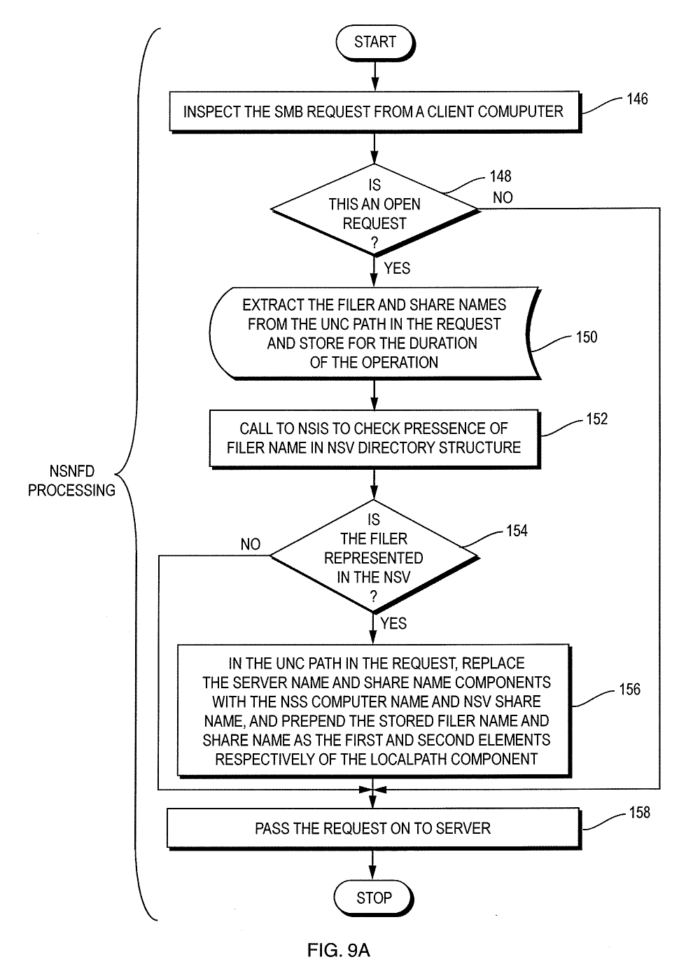

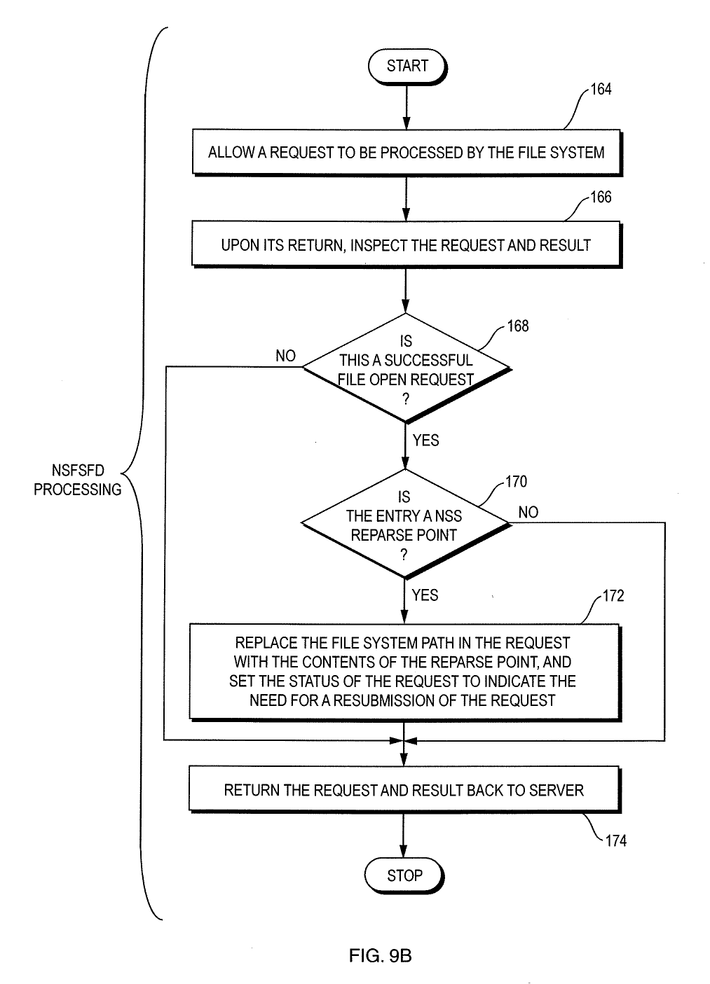

The Name Space Network Filter Driver (NSNFD) 62 of the NSS 60 intercepts and modifies network requests received from the client computers 24 before the request is received by the SMB server Software 54, as further described below with respect to FIG. 9B.

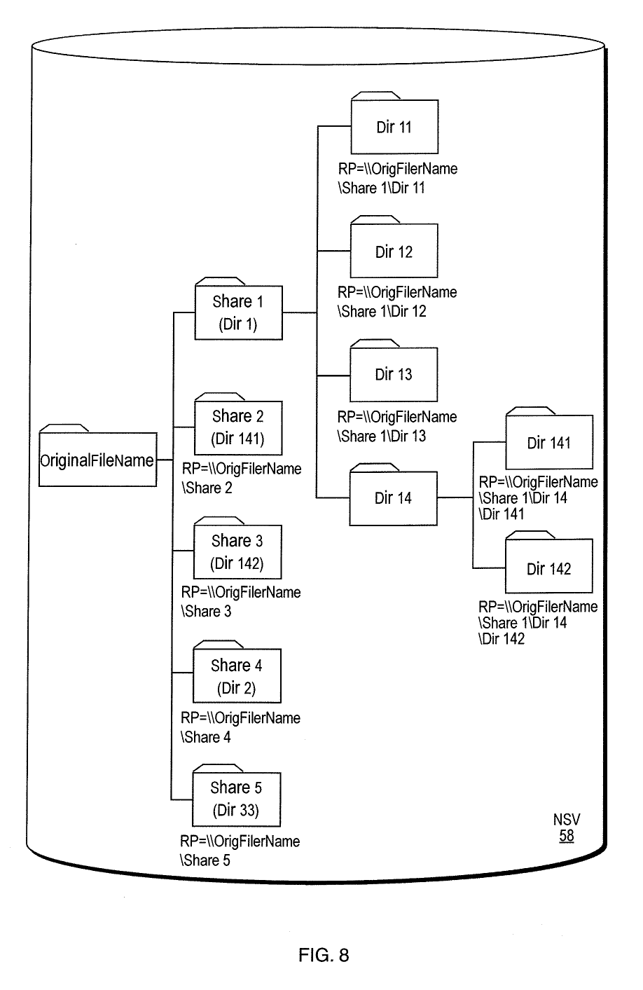

The Name Space File System Filter Driver (NSFSFD) 66 of the NSS 60 intercepts file system requests directed by the server 28 to the NSV 58 within the Input/Output (I/O) subsystem 56 in the local Operating System (OS). The NSFSFD 66 of the NSV 58 is a primary component of the system 30 that provides Reparse Point functionality to cause the request be reissued by the client computer 24 with a revised file location as further described below with respect to FIG. 8.

The Name Space Information Server (NSIS) 64 provides a lookup service to the NSNFD described in further detail below with respect to FIG. 9A, and creates and maintains the directory structure on the NSV. It also maintains a database relating filer and share names to the directory location in the NSV of the Reparse Points that refer to them so that the SMM can locate the appropriate Reparse Points to modify when migrating a share from one filer to another.

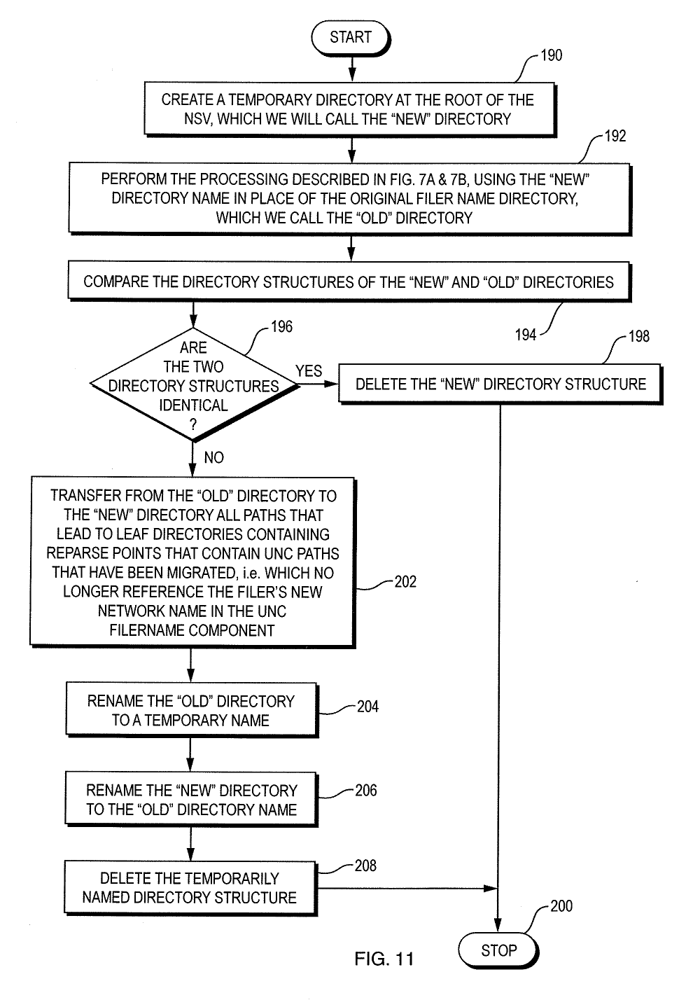

In addition to the components discussed above, the NSS 60 has two additional components, that of a filer inventory module (FIM) 68 and a share migration module (SMM) 70. The Filer Inventory Module (FIM) 68 is configured on the server computer 28 in the network system 20. The FIM 68 will be further described with respect to the filer inventory and re-inventory functionality described in FIGS. 7A & 7B and 11. The Share Migration Module (SMM) 70 is configured on the server computer 28 in the network system 20. The SMM 70 is one of the portions of the NSS 60 that provides the functionality to keep the NSV 58 up to date as described below with respect to FIG. 11.

While the FIM 68 and the SMM 70 are shown on server computer 70, it is recognized that the FIM 68 and the SMM 70 could reside on different server computers 28. While the FIM 68 and the SMM 70 could each reside on a separate server computers 28 or both could reside on the server computer or server 28 hosting the NSS 60. In either situation, the FIM 68 and SMM 70 are operated under central administrative control and communicate with the NSIS in order to act on the NSV 58.

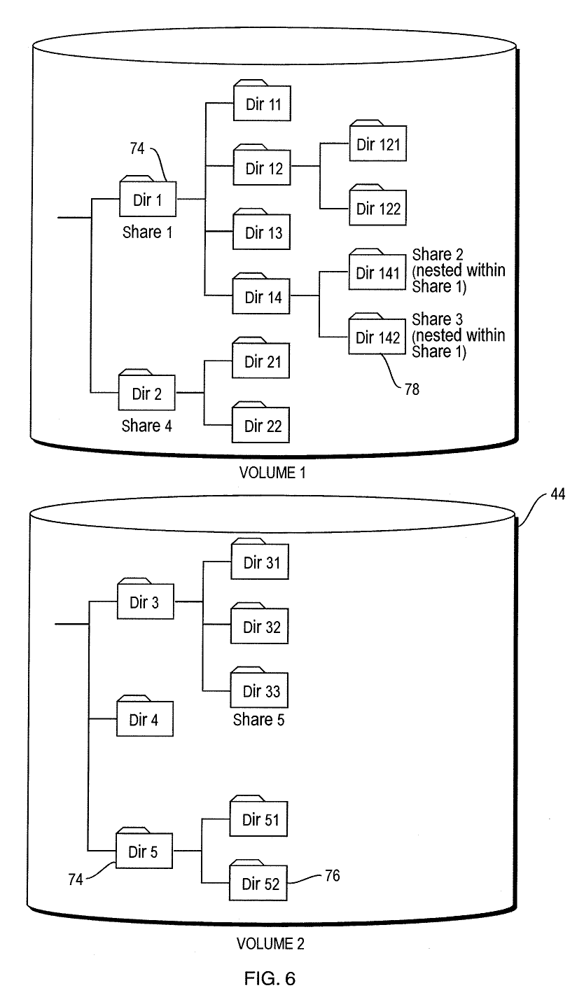

Referring to FIG. 6, a diagram of a pair of storage volumes 44 in a filer computer 26 is shown. Each of the storage volumes 44 has a plurality of directories 74. Each of these directories may have one or more subdirectories 76. For example in FIG. 6, directory 1, directory 2, directory 3, and directory 5 of the directories 74 are each shown having two or more subdirectories 76. The folder labeled “Dir 4” does not have a subdirectory and would contain files 72 of data. Any of the directories could contain files of data as well as subdirectories. A combination is possible.

In addition, subdirectories 76 can have subdirectories 78 such as shown with the folder labeled “Dir. 14”. Referring back to FIG. 2, the path \Staff\Accounting\JohnJolly\Resume.doc could relate to the storage volume 44 in FIG. 6 as the Staff folder is Directory 1, the Accounting Folder is Directory 14, and the JohnJolly folder is Directory 141. The resume.doc document is located in Directory 141.

Referring to FIGS. 7A and 7B, a flowchart describing the process of constructing an inventory of a filer to be managed is shown. The FIM 68 can inventory the directories on the filer computers. Referring to FIG. 7A, the process is initiated by either a computer administrator running the system or by the system self-initiating, such as more typically in re inventory which is explained below with respect to FIG. 11. The start of the process is represented by block 80.

The FIM 68 of the NSS 60, as shown in FIG. 1, assigns a new, unused network name for the filer. For example, if the filer has the name ACCOUNTING_SERVER, the FIM might assign the name ACC_SER1_{—}03556. While a new name is created the system 20 does not yet apply the name in the network. This step is represented by block 82. The FIM creates a directory within the NSV with the original network name of the filer as represented by block 84. The original network name being the name that filer has prior to the initiation of the process; for example, if the filer has the name ‘ACCOUNTING_SERVER1, and the NSV is the F: drive on the NSS computer, then NSIS would create a directory F:\ACCOUNTING_SERVER1

Referring to block 86 in FIG. 7A, the FIM uses available OS APIs (Application Program Interface) calls to obtain information about shares published by the filer.

The FIM then creates a subdirectory within the filer directory on the NSV 58 as represented by block 88 for each of the shares the filer publishes. The FIM uses the volume information associated with each share to establish how much of the directory structure of the share to analyze, and from the analysis, how much to replicate in the NSV. For example, referring to FIG. 6, of the directories 74, directory 1 and directory 2 are shares and analyzed. However, directories 3, 4, and 5 are not shares, therefore these directories 74 are not analyze. With respect to directory 1, it has a pair of nested shares and therefore when analyzing directory 1, the system would replicate to the level of subdirectories 76 of “Dir. 11,” “Dir. 12,” Dir. 13,” and “Dir. 14.” Since subdirectories 76 121 and 122 are not peers of any subdirectory in the path from the share at Directory 1 to either of the only nested shares Dir 141 and 142, they do not need to be replicated. Subdirectories “Dir. 33,” “Dir 141,” and “Dir 142” are each shares that would be analyzed. However, since neither of the shares at Dir 141 and Dir 142 has any nested shares, no more analysis is required.

Referring back to FIG. 7A, within each share subdirectory, the NSIS 64 creates a directory tree mirroring only enough of the directory structure at the original filer necessary to relate shares that may be nested. A nested share is defined as a published directory that is itself within the directory structure of another share. An example of nested share is Share 2, directory 141, which is a subdirectory 78 of a subdirectory 76, directory 14, of a directory 74 labeled “Dir 1” which is Share 1.

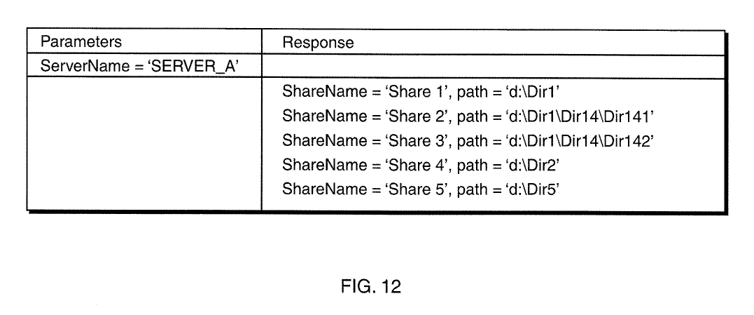

The next several blocks explain the process. Referring to block 90, the FIM obtains a list of shares from the filer using APIs within the OS which communicate with the filer over the network, such as the Windows Win32 NetShareEnum call which enumerates shares at a computer, and obtains information about each. As an example, a call to the NetShareEnum API to inquire about a filer with the directory structure described in FIG. 11 would result in a raw list of share information as summarized in FIG. 12. The FIM then extracts a list of shares the directory trees of which contain no other shares. In other words, if a share has a path that includes the complete path of any other share, that share is not a root share. On the other hand, if a share has a path that does not include the complete path of any other share, it is a root level share.

FIM then processes the root level share list to record for each entry a list of next level nested shares, i.e. that are within the directory tree of the root share, but that are not within the directory tree of any other share. Record the level as the current nested level. Thus each entry in the root share list that has nested shares will have a list of nested shares. Those lists would be at a nesting level of 1. Any share entry in any of those lists that had shares nested within its directory structure would have a list of those nested shares which would be considered to be at a nesting level of 2, and so on. For example referring back to FIG. 6, shares 1 4 and 5 would be root share list entries, since none of them are mapped to locations within any other share's directory structure. However, shares 2 and 3 would be entries in the level 1 nested share list of share 1.

After that step, still referring to FIG. 7A, each share listed at the current nested level is processed, as represented by block 92, to record for each entry a list of next level nested shares, i.e. that are within the directory tree of the current level nested share, but that are not within the directory tree of any other share. This is now the current nested level.

Block 94 in FIG. 7A, represents the repetition of the process for the lists generated in the previous step of block 92 until all shares have been processed into a share list at a root or nested level. The arrow from block 94 back above block 92 indicates the iterative process that occurs until all the shares have been processed.

Once the shares have been processed, an entry in the root share list is processed as represented by block 96. After the entry is processed, a subdirectory for the share within the original filer name directory is created on the NSV, as represented by block 98.

Further processing related to the share entry is described in association with FIG. 7B. The off page reference blocks 100 represent the connection to FIG. 7B.

Referring to FIG. 7B, the link to FIG. 7A and the off page reference block 100 is represented by off page reference block 108. A directory for the share within the filer directory entry discussed above with respect to block 98 is created as represented by block 110.

The NSS 60 determines if there are “any entries in the list of next level shares associated with this share?” as represented by the decision diamond 112. The term next level means the level of directory 74 or subdirectory 76 below the current level. If there are no entries as represented by the “No” branch, the process flows to the step of “Write the directory for this share as a Reparse Point containing a UNC path in the form \\NewFilerNetworkName\ShareName.” This step is represented by block 114. For example referring to FIG. 8, the Share 2 has a Reparse Point of \\OrigFilerName\Share 2. The file name would post append to this point.

After block 114, the process checks to see if at the root level as represented by decision diamond 115. If yes as represented by the “yes” branch, the process controlled by the FIM returns to FIG. 7A through the off page reference block 116 to the off page reference block 100.

If there are additional entries as represented by the “yes” branch from decision diamond 112, then the list of next level shares associated with this share (now called the ‘parent’ share) is processed. Block 118 represents the beginning of the process, but several of the steps are explained in further detail with respect to further blocks.

FIM creates a Reparse Point at each leaf subdirectory within the resultant filer directory structure containing the UNC path to the physical location of the corresponding directory at the original filer. The server component of the UNC path contains the network name for the filer assigned during the inventory process.

For leaf subdirectories which are not shares, but exist as subdirectories of a parent share at the level of one or more nested shares, FIM creates a Reparse Point that incorporates the directory path elements from the parent share to the leaf subdirectory as represented by block 126.

The first step is to process the next share entry in the list as represented by block 120. This is followed by a directory structure created within the directory created for the parent share that contains the additional path to this share, together with, for each element in the additional path, a directory for each sibling of that element. This step is represented by block 122.

In that there are multiple levels and may be nested shares, the process is recursive as represented by block 124. That is the terms are dependent on the terms of other levels.

After the recursive process described above, a Reparse Point containing a UNC path in the form \\NewFilerName\ParentShare\PathFromShareToLeaf is written at each leaf directory as represented by block 126. A leaf directory is a directory that does not have any child directories. For example, referring to FIG. 6, directory 13 is a leaf directory while directory 14 is not.

The FIM determines if the last entry on the list has been reached as represented by the decision diamond 128. If the last entry on the list has not been reached, the FIM loops the process back up to process the next share entry in the list which discussed above and is represented by block 120.

If the last entry on the list has been reached, the FIM loops the process back up and return to the entry whose nested share list was just process as represented by block 130.

If the last entry on the list has been reached as represented by the “Yes” branch of the decision diamond 128. After diamond 128, the process checks to see if at the root level as represented by decision diamond 115. If yes as represented by the “yes” branch, the process controlled by the FIM returns to FIG. 7A through the off page reference block 116 to the off page reference block 100.

Referring to FIG. 7A, the FIM determines if the last entry on the list has been reached as represented by the decision diamond 102. If the last entry on the list has not been reached, the FIM of the NSS 60 loops up to process an entry in the root share list which was discussed above and is represented by block 96.

If the last entry on the list has been reached as represented by the “Yes” branch of the decision diamond 102, the FIM applies the network name assigned above to the filer using remote computer management protocols as represented by block 104.

FIM creates a record within DNS such that address searches for the original network name of the filer resolve to the network address of the computer that hosts the NSS, as represented by block 105.

Referring to FIG. 8, a diagram of name space representation is shown. FIG. 8 shows the resultant directory structure at the NSV as a result of the processing in FIGS. 7A and 7B being applied to the example filer configuration shown in FIG. 6.

While a termination symbol, as represented by oval 106 is shown in FIG. 7A, it is recognized that the above only describes one process the NSS 60 accomplishes. The following describes other processes.

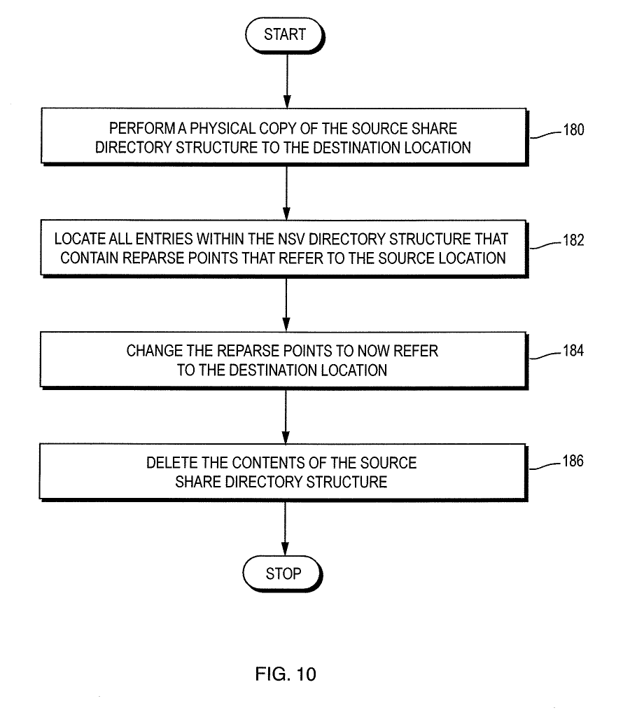

The filer directory structure will be modified only by the re-inventory process as discussed below with respect to FIG. 11. The Reparse Point will only be modified by the Migration process as discussed below with respect to FIG. 10.

Referring to FIG. 9A, a flowchart showing the process of virtual path resolution, by which the client computer gains access to the data at its physical location is shown. When application software 36 on a client computer 24 needs a file (data), the software 36 submits a file system ‘open’ request using the UNC path that references the target resource. The UNC path is the direction to where the application software 36 believes the file resides on a storage volume 44 on one of the filer computers 26.

The SMB client software 32 component in the OS on the client computer 24 submits a request to DNS, which is a distributed system located throughout the system 20, to search for the network address for the filer component in the UNC path. As a result of the inventory process, DNS responds with the network address of the NSS 60.

The SMB client now submits a request to that network address specifying the share and path components of the file location. Referring to FIG. 9A, the name space network filter driver (NSNFD) 62 intercepts the SMB request from the client computer 24 as it arrives at the NSS 60 located on the server computer 28. This step is represented by block 146.

As way of example, the client computer 24 has a UNC path in the form \\OriginalFilerName\OriginalFilerShare\DirA\DirB\MyFile where \DirA\DirB\MyFile represents the path requested by the application within the directory structure anchored by the OriginalFilerShare on the filer OriginalFilerName. In the previous step in the process, the client computer 24 was given the network address of the NSS server computer because of the DNS alias for the original filer name. So it directs its request with the same UNC path to the NSS server computer. As a result of the machinations of the NSNFD (the network filter driver), the UNC path that is actually received by the Microsoft OS server software running on the NSS server computer is now in the form \\NSSServerName\NSVShareName\OriginalFilerName\OriginalFilerShare\DirA\DirB\MyFile. The effect of this is that the path that is navigated in the NSV is for a path \OriginalFilerName\OriginalShareName\DirA\DirB\MyFile.

The NSNFD 62 of the NSS 60 determines if there is an open request, as represented by decision diamond 148. If there is no open request as represented by the “no” branch, the request is passed to the server as represented by block 158. If there is an open request as represented by the “yes” branch, the NSNFD 62 of the NSS 60 extracts the filer and share names from the UNC path in the request and stores the filer and share names for the duration of the operation as represented by block 150.

The NSNFD 62 then calls to the NSIS 64 to check for the presence of filer name in NSV directory structure 58 as represented by the decision diamond 154. If there is no filer represented in the NSV directory structure 58 as represented by the “no” branch, the request is passed to the server as represented by block 158.

If the filer is represented in the NSV directory structure 58, the NSNFD 62 replaces the server name and share name components in the UNC path in the request with the NSS computer name and NSV share name, and prepends the stored filer name and share name as the first and second elements respectively of the local path component as represented by block 156. So if the NSS computer network name is NSS_COMPUTER and the NSV share names is NSV_SHARE, and the original filer name is FILER_A and the original share was SHARE_{—}1, then an example of the UNC path in the request sent by the client computer might be \\SERVER_A\SHARE_{—}1\DirA\DirB\MyFile. After the NSNFD modifications described, the request that is forwarded to the server would contain a UNC path of \\NSS_COMPUTER\NSV_SHARE\SERVER_A\SHARE_{—}1\DirA\DirB\MyFile.

Still referring to FIG. 9A, after the replacement described with respect to block 156, the request is passed to the server as represented by block 158.

The SMB request contains the UNC path to the resource being targeted by the client computer 24. The NSNFD 62 communicates with the NSIS to enquire if the filer is represented in the NSV.

The modified request is then processed by the server, which translates the share name into a directory location on a volume. In the embodiment described, the directory location is the root directory of the NSV 58. The server then processes successive elements of the local path component of the modified UNC path, and generates file system requests to open each element as a child of the prior element. The NSFSFD 62 intercepts each request. As a result of the inventory processing described above with respect to FIGS. 7A and 7B and below with respect to re-inventory and FIG. 10, one of the successive requests will open a leaf directory in the NSV directory structure 58, triggering Reparse Point functionality. At this point referring to FIG. 9B, the NSFSFD 66 modifies the response to the request with a status indicating that a reparse of the request is required of the client, and that the path elements processed so far should be replaced by the metadata stored in the Reparse Point. The metadata was created by Initial Filer Inventory as described above with respect to FIGS. 7A and 7B, by the Re-inventory as described below with respect to FIG. 10, or by the share migration as described below with respect to FIG. 11, if the share has been migrated.

Referring to FIG. 9B, a flowchart describing the processing at the server computer of an SMB interaction with a client computer using the Names Space File System Filter Driver 66 is shown. The NSFSFD 66 of the NSV 58 allows a request to be processed by the file system driver as represented by block 164, that is the NSFSFD 66 intercepts the a request and forwards the request on to the file system driver to be processed with altering the request. The file system driver in an embodiment is software that can manipulate a particular type of layout of data, files and directories on a disk volume.

When the request and result is returned to the NSFSFD 66, the NSFSFD 66 inspects the request and result as represented by block 166. The NSFSFD 66 determines if the request was a successful file open request as represented by decision diamond 168. If there is no successful file open request as represented by the “no” branch, the request and the result is returned back to the server as represented by block 174.

If there is a successful file open request as represented by the “yes” branch, the NSFSFD 66 determines if the entry is a NSS Reparse Point as represented by the decision diamond 170. If the entry is not a NSS Reparse Point as represented by the “no” branch, the request and the result is returned back to the server as represented by block 174.

If the entry is a NSS Reparse Point as represented by the “yes” branch, the NSFSFD 66 replaces the file system path in the request with the contents of the reparse point, and sets the status of the request to indicate the need for a resubmission of the request as represented by block 172. The request and the modified result are returned back to the server as represented by block 174.

Server transmits the reparse status and metadata to the client computer. The client computer reissues the request, which now contains the UNC path to the filer that currently holds the resource. All subsequent interactions concerning the open resource will be conducted directly between the client computer and the target filer, without any involvement of the NSS, until the resource is closed by the client computer.

Referring to FIG. 10, a flowchart describing the process for migration of a share from one filer to another is shown. The Share Migration Module (SMM) 70 is invoked when a specified user, such as the system administrator, needs to migrate a share, including its directory structure and file data, to another physical storage location. The specified user, the administrator, supplies source and destination filer and share information.

The destination of the migration must itself be a filer that is being managed be the computer system 20 and the NSS 60, which is represented in the NSV 58. The destination share does not yet exist.

SMM 70 uses remote computer management protocols to disable the source share at the source filer, and to create the destination share at the destination filer.

SMM 70 copies the directory structure and file data from source share to destination share as represented by block 180 in FIG. 10. In one embodiment, the physical copying process is a recursive walk of the source directory structure, directories are created on the target as they are encountered in the source, and files encountered within those source directories are copied into the corresponding directories at the target now that they have been replicated.

Once the physical copy is complete, SMM 70 communicates with NSIS to find the Reparse Point(s) associated with the share that has been migrated as represented by block 182.

The SMM 70 of the NSS 60 updates the Reparse Point metadata with the UNC path of the destination as represented by block 184. The SMM 70 may then delete the directory structure and file data from the source share at the source filer as represented by block 186. In one embodiment, the directory contents are deleted using a recursive walk of the directory tree during which deepest level files and empty subdirectories are deleted, followed by their parents, followed by their parents, and so on until the entire structure has been removed.

Finally SMM 70 uses remote computer management protocols to remove the source share at the source filer.

Referring to FIG. 11, a flowchart describing the process of re-inventorying a filer is shown. Although the filer computers 26 and the storage volumes 44 are managed by the computer system 20 and the NSS 60 as described above, other systems or specific users may affect the filer computer 26 therefore the NSS 60 does not have exclusive control. As a result, a specified user, such as an administrator, may decide to create or remove shares from the filer computer 26 and a specific storage volume 44. In order for the NSS 60 to maintain an accurate representation of the filer, the NSIS 64 automatically re-inventories the filer and applies changes to the filer's directory structure on the NSV 58 according to a schedule specified by the system administrator. The processing involved is described in the flowchart in FIG. 11.

The NSS 60 creates a temporary directory at the root of the NSV 58, which is referred to as the ‘NEW’ directory in this embodiment. This step is represented by block 190.

The NSS 60 performs the processing described in FIGS. 6A & 6B, using the NEW directory name in place of the original filer name directory, which is referred to as the ‘OLD’ directory in this embodiment. This step is represented by block 192.

The NSIS 64 compares the results of an inventory process as described in Initial Filer Inventory described above with respect to FIGS. 7A and 7B with the current NSV directory structure as represented by block 194.

The NSIS 64 of the NSS 60 compares the two directories to determine if the structures are identical as represented by decision diamond 196. If the structures are identical as represented by the “yes” branch of the diamond 196, the NSS 60 deletes the ‘NEW’ directory structure as represented by block 198. In this situation, this specific process is completed as represented by the termination oval 200.

If the structures are not identical as represented by the “no” branch of the diamond 196, the NSIS 64 of the NSS 60 transfers from the OLD directory to the NEW directory all paths that lead to leaf directories containing Reparse Points that contain UNC paths that have been migrated as represented by block 202. Therefore the NSIS 64 transfers from the OLD directory all paths which no longer reference the filer's new network name in the UNC FilerName component.

The NSIS 64 then renames the OLD directory to a temporary name as represented by block 204. Rename the NEW directory is then renamed to the OLD directory name as represented by block 206.

The NSIS 64 of the NSS 60 then deletes the temporarily named directory structure as represented by block 208. After the deletion of the temporarily name directory structure, this specific process is completed as represented by the termination oval 200.

Further explaining block 202, if a share exists in NSV 58 but no longer exists at the filer, then if the corresponding Reparse Point metadata does not indicate that the share has been migrated, NSIS 64 removes the share directory in the NSV 58. If the share was a nested share, then NSIS 64 removes the mirrored directory structure within the parent share that leads to the removed share.

If a share exists at the filer, but is not represented in the NSV 58, then NSIS 64 creates a directory for it within the filer directory. If the new share is a nested share, or the new share has nested shares, NSIS 64 creates a directory tree from the parent share mirroring only enough of the directory structure at the filer necessary to relate the new or nested share, respectively.

If a share exists in the NSV 58, and on the filer, then if it is a parent of one or more nested shares, and if the mirrored directory structure in the NSV 58 no longer accurately represents the necessary structure as it exists at the filer, NSIS 64 will remove and create leaf directories as necessary.

As in the Initial Filer Inventory, for new leaf subdirectories which are not shares, but exist as subdirectories of a parent share at the level of one or more nested shares, NSIS 64 creates Reparse Point metadata that incorporates the directory path elements from the parent share to the leaf subdirectory.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

While the above embodiment is described using terminology used with a Windows Operating System (OS), it is recognized that other operating system which support features can be used. For example, Unix/Linux variants of network client software at the time of filing did not support referral or redirection mechanism, but is recognized that later versions may support all elements of the system.

What is claimed is:

1. A system for storing data on a network or backbone, the system comprising:
a server computer having an SMB driver, server software, a file system driver, and a name space system, the server computer connected to the backbone;
a filer computer containing a plurality of data, the filer computer connected to the backbone;
at least one client computer, the at least one client computer connected to the backbone for accessing data from the filer computer;
the name space system including
a NSV (name space volume) containing a representation of data on the filer;
a NSNFD (Name Space Network Filter Driver) interposed between the backbone and the SMB driver of the server computer for modifying the request (the filer and share name) from the at least one client computer prior to forwarding to the server software;
a NSFSFD (Name Space File System Filter Driver) interposed between the server software and the file system driver for providing Reparse Point Functionality in the NSV for the at least one client computer therein the at least one client computer reissues the request for data with a revised file location;
a NSIS (Name Space Information Server) maintaining a database relating the filer and share name to the location in the NSV of representation of a specific data on the filer
wherein the UNC path stored on the at least one client computer can locate the data (independently) regardless of the actual physical location on the filer computer.

2. A system of claim 1 wherein the plurality of data are located on a plurality of storage volumes on a plurality of filer computers and wherein the data is located in a directory structure including at least one root folder, a plurality of shared folders, and a plurality of non shared folders, the data located in the plurality of folders.

3. A system of claim 1 wherein the NSV further comprises
a FIM (Filer Inventory Module) interconnected with the NSIS for creating and updating the representations in the NSV;
a SMM (Share Migration Module) interconnected with the NSIS for moving data from one filer share to another.

4. A Name Space System comprising:
a NSV (name space volume) containing a representation of the organization of the shares on the filer;
a NSNFD (Name Space Network Filter Driver) interposed between the backbone and the SMB driver software of the server computer for modifying the request including the filer and share name from the at least one client computer prior to forwarding to the server software;
a NSFSFD (Name Space File System Filter Driver) interposed between the server software and the file system driver for providing Reparse Point Functionality in the NSV for the at least one client computer therein the at least one client computer reissues the request for data with a revised file location;
a NSIS (Name Space Information Server) maintaining a database relating the filer and share name to the location in the NSV of representation of a specific data on the filer
wherein the UNC path stored on the at least one client computer can locate the data (independently) regardless of the actual physical location on the filer computer.

5. A method of managing data retrieval comprising:
providing a server computer and a filer computer containing a plurality of data, the server and the filer computer connected to a backbone;
requesting data from the backbone by a client computer;
intercepting the request for data by a name space system;
determining by the name space system if path for data has been modified;
modifying by the name space system of the path for data;
forwarding by the name space system of the path for data to the client computer requesting the data.

6. A method of claim 5 wherein
assigning by the FIM in the NSS of a new unused network name for a filer;
creating a directory on the NSV having the network name of the filer wherein the data is physically located;
creating a subdirectory within the directory on the NSV for each of the shares located on the filer; and
applying by the FIM the new unused network name to the filer.

7. A method of claim 6 wherein the FIM uses the volume information associated with each of the shares to determine what subset of the directory structure of the share to analyze and record in the NSV.

8. A method of claim 6 wherein a Reparse Point is created by the FIM at each leaf subdirectory within the directory on the NSV, the Reparse Point containing the UNC (Uniform Naming Convention) path to the physical location of the data.

9. A method of claim 5 wherein
submitting by a client application on one of the client computers an open request using the UNC path related to the data using the SMB (Server Message Block) protocol;
requesting by the one of the at least one client computer to the DNS (network address resolution directory) to obtain the network address of the filer name in the NC path relative to the data;
responding by the DNS with the network address of the NSS server computer, wherein the network name of the filer exists in a directory on the NSV;
intercepting by the NSNFD (Name Space Network Filter Driver) the SMB request which includes the filer and share names and the local path components of the data; and
enquiring by the NSNFD of the NSIS whether the filer name is represented in the NSV;
wherein the NSIS looks up in the root directory of the NSV and communicates the result to the NSNFD.

10. A method of claim 9 wherein if filer is located on the NSV, further comprising:
extracting by the NSNFD the filer and shared components of the UNC path from the open request and storing them temporarily;
replacing by the NSNFD the filer name component of the UNC path with the NSS computer network name and the share component of the UNC path with the NSV share name;
prepending by the NSNFD of the NSS, the stored filer name and share to the local path component of the UNC path as the first two elements;
forwarding by the NSS of the modified request to the SMB driver on the server; and
submitting a file system open request by the SMB driver containing the modified local path component of the UNC path in the request to the file system driver on the server computer.

11. A method of claim 10 further comprising:
looking up each successive element of the local path within the NSV subdirectory identified by the preceding element by the file system driver;
determining if a matching subdirectory is found for an element which is a leaf directory in the NSV directory structure, the leaf directory having been marked as a Reparse Point, in which case the file system driver ceases processing further elements of the local path in the open request;
sending a response back to the server software indicating that a reparse point has been encountered.
intercepting by the NSFSFD the response returned by the file system driver;
using the contents of the reparse point to cause the local path elements processed up until the reparse point was encountered to be replaced by a UNC path representing the physical location of the remaining, unprocessed local path;
forwarding the modified result to the server software; and
sending the result back to the client computer.

12. A method of claim 10 wherein the all the elements of the local path in the file system open request match a subdirectory and the final element does not match a leaf subdirectory, further comprises
responding by the file system driver with a successful status, indicating that the local path has been successfully opened;
forwarding by the NSFSFD the result to the server software without modification; and
sending by the server software the successful result back to the client computer.

13. A method of claim 9 wherein if the filer is not located on the NSV, further comprising passing through to the server software the request from the client computer unmodified by the NSNFD.

14. A method of claim 5 further comprising:
comparing by the FIM (Filer Inventory Module) of a current directory structure in the filer computer to a specified directory structure in the NSV (name space volume); and
modifying the specified directory structure in the NSV to reflect the current directory structure in the filer computer, wherein the FIM is able to maintain an accurate representation of the filer.

15. A method of claim 14 wherein if a share exists in NSV but no longer exists at the filer and the corresponding Reparse Point does not indicate that the share has been migrated, the FIM removes the share directory in the NSV.

16. A method of claim 14 wherein if a share exists at the filer, but the share is not represented in the NSV further comprising:
creating a directory by the FIM for the share within the filer directory in the NSV.

17. A method of claim 16 wherein if the new share is a nested share, further comprising:
creating a directory tree by the FIM from the parent share mirroring only enough of the directory structure at the filer necessary to relate the new nested share.

18. A method of claim 5 further comprising:
receiving of a source and a destination of data to migrate by the name space system;
disabling by the SMM (Share Migration Module) of the source share at the source filer;
creating by the SMM of the destination share at the destination filer;
communicating by the SMM with the NSIS to find the Reparse Point of the share;
updating by the SMM of the Reparse Point data with the UNC path of the destination filer and share; and
removing by the SMM of the source share at the source filer.

19. A method of claim 18 further comprising:
copying of the data from the source filer to the destination filer; and
deleting the data and the directory structure from the source filer.
